(19) United States
(12) Patent Application Publication
(10) Pub. No.: US 2009/0262784 A1
(43) Pub. Date: Oct. 22, 2009

(54) MIXER CIRCUIT AND COMMUNICATION APPARATUS INCLUDING MIXER CIRCUIT

(75) Inventor: Masayuki IKEDA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/394,913

(22) Filed: Feb. 27, 2009

(30) Foreign Application Priority Data
Feb. 29, 2008 (JP) 2008-049294
Feb. 25, 2009 (JP) 2009-041908

(51) Int. Cl. H04B 1/00; G06G 7/12

(52) U.S. Cl. 375/130; 375/260; 327/359; 375/E01.001

(57) ABSTRACT

A mixer circuit which outputs a first output signal and a second output signal, in which are mixed a first input signal and a second input signal, includes a first grounded source amplifier circuit which amplifies the first input signal, a second grounded source amplifier circuit which amplifies the second input signal, a first signal output unit which outputs the first output signal, a second signal output unit which outputs the second output signal, a first transistor group including n rows and m columns (n is an integer equal to or greater than two, m is an integer equal to or greater than two) of transistors connected between the first grounded source amplifier circuit and the first signal output unit, a second transistor group including n rows and m columns of transistors connected between the first grounded source amplifier circuit and the second signal output unit, a third transistor group including n rows and m columns of transistors connected between the second grounded source amplifier circuit and the first signal output unit, a fourth transistor group including n rows and m columns of transistors connected between the second grounded source amplifier circuit and the second signal output unit, and n×m×k (k is 1 or 2) control signal lines to which n×m×k control signals which drive the first transistor group and the second transistor group, and drive the third transistor group and the fourth transistor group.

### BACKGROUND

1. Technical Field

The present invention relates to a mixer circuit used in a communication apparatus, and in particular to a mixer circuit, and a communication apparatus including the mixer circuit, appropriate to ultra wideband (UWB) communication.

2. Related Art

The UWB communication is a communication method which carries out a communication of a large amount of data at high speed, utilizing an extremely wide frequency band. Among communication methods utilizing a wideband signal, there is a heretofore known method using a spectral diffusion, and an orthogonal frequency division multiplexing (OFDM), but the UWB being a wider band communication method utilizing an extremely short pulse, it is also called an impulse radio (IR) method of communication. Hereafter, this will be referred to as a UWB-IR, or simply IR method. With the IR method, modulation and demodulation being possible with only a time axis operation, which does not depend on a heretofore known modulation, a simplification of a circuit, and a reduction in power consumption, can be expected (refer to U.S. Pat. No. 6,421,389, U.S. Patent Application No. 2003/0108133A1, and U.S. Patent Application No. 2001/0033576).

Firstly, FIG. 12A shows a typical block diagram of a heretofore known IR type of UWB transceiver apparatus, while FIGS. 12B and 12C show timing diagrams illustrating an outline of an operation thereof. Using the diagrams, a simple description will be given of the operation and a principle of the apparatus.

Data to be transmitted are input into a terminal 1201. A pulse generator circuit 1202 generates a wideband pulse. At this time, the pulse generator circuit 1202 receives a transmission data signal input into the terminal 1201, and performs a predetermined modulation on the generated pulse. As a modulation method, a pulse position modulation (PPM), which displaces the generation position of the generated pulse, a bi-phase modulation (BPM), which inverts the polarity of the generated pulse, and the like, are often used. A PPM waveform is shown in FIG. 12B, while a BPM waveform is shown in FIG. 12C. In the same figures, a solid line and a broken line represent bit 1 or 0 respectively. The pulse generated and modulated in this way is emitted into space via a transmission antenna 1203.

Next, a description will be given of a heretofore known typical receiving apparatus. A signal received by a receiving antenna 1204 is amplified by a low noise amplifier (LNA) 1205, and sent to a mixer circuit 1206. At this time, an equalizing process removing distortion brought about in a transmission path, and the like, is appropriately carried out. As an example of distortion, there is distortion due to a multipath, a frequency shift due to the Doppler Effect, and the like.

The received signal amplified by the LNA 1205 is sent to the mixer circuit 1206, and a multiplication is carried out with a template pulse generated by a template pulse generator circuit 1208. The mixer circuit 1206, being one kind of multiplier circuit, outputs a value of two signals (in this case, the received signal and the template pulse) multiplied together. The signal output by the mixer circuit 1206 is smoothed by an integrating circuit 1210, transmitted bit information is determined from the result thereof by a determination circuit 1212, and output from a terminal 1213 as a demodulated output. That is, the mixer circuit 1206 and the integrating circuit 1210 configure a correlator, and a correlation between the received signal and the template pulse is calculated by this circuit. The determination circuit 1212 carries out a determination (a demodulation) on a transmitted signal based on the result of the correlation calculation.

The outline of the operation of the heretofore known IR type of UWB transceiver apparatus will be shown, based on the timing diagrams of FIGS. 12B and 12C.

A received signal b received by the receiving antenna 1204, and amplified by the LNA 1205, is of the kind of waveform shown in FIG. 12B. In the following description, the solid line shows the case of bit 1 having been sent, and the broken line the case of bit 0 having been sent. The template pulse generator circuit 1208 generates the kind of bit 1 template pulse c shown in FIG. 12B. The mixer circuit 1206 multiplies the received signal b and the template pulse c, and outputs a multiplication result signal e. After the multiplication result signal e is integrated by the integrating circuit 1210, and a high frequency component is removed, it is input into the determination circuit 1212, and determined as transmitted information in the determination circuit 1212 from the size of the correlation value.

Heretofore, the case of detecting a bit 1 signal has been shown but, in the event of detecting a bit 0 signal, the template pulse generator circuit 1208 generates bit 0 template pulse d instead of the bit 1 template pulse c, the mixer circuit 1206 multiplies the received signal b and the template pulse d, and outputs a multiplication result signal f.

A receiving method which calculates a correlation with a template pulse, and demodulates, in this way is generally referred to as a synchronized detection method. With the synchronized detection method, a timing of the template pulse and the received signal must coincide perfectly. With the heretofore known example given here, for a synchronized tracking, a timing of a template pulse generation in the template pulse generator circuit 1208 is adjusted from the determination circuit 1212 determination result in such a way that the correlation value is consistently at a maximum. Although this operation is generally not easy, it is said that, by making full use of recent advances in device technology and digital signal processing technology, a stable operation has become possible even at a high frequency.

FIG. 12C is a diagram illustrating the outline of the operation of the heretofore known IR type of UWB transceiver apparatus in the case of a BPM. A received signal g received by the receiving antenna 1204, and amplified by the LNA 1205, is multiplied by the mixer circuit 1206 with a template pulse h generated by the template pulse generator circuit 1208, giving a multiplication result signal i. By removing a high frequency component of the multiplication result signal i with the integrating circuit 1210, and determining its positivity or negativity with the determination circuit 1212, it is possible to determine whether the transmitted bit information is 1 or 0. Even when using a low frequency pass filter (LPF) instead of the integrating circuit 1210, as it is essentially of equal value in making a correlation, there is no problem.

With the IR type of UWB communication, the signal being intermittent, the signal is not consistent in the way of the heretofore known narrowband communication. For this reason, it is known that, by supplying power to the receiver circuit only when there is a received signal (or when it is predicted that a signal can be received), and blocking the circuit when there is no signal, it is possible to considerably reduce the power consumption of the receiving apparatus as a whole (for example, refer to Non-patent Document 1: “A CMOS IMPULSE RADIO ULTRA-WIDEBAND TRANSCEIVER FOR 1 Mb/s DATA COMMUNICATION AND±2.5 cm RANGE FINDINGS”, T. Terada et al, 2005 Symposium on VLSI Circuits Digest of Technical Papers, pp. 30 to 33).

In FIG. 12A, it is possible to use a circuit shown in Non-patent Document 1, or in Non-patent Document 2: “A Low-Power Template Generator for Coherent Impulse-Radio Ultra Wide-Band Receivers”, Jose Luis et al, Proceedings IEEE ICUWB, 2006 pp. 97 to 102, for the pulse generator circuit 1202 and the template pulse generator circuit 1208. It being possible to configure these circuits by means of a digital circuit, it is possible to design them in such a way that, using a complementary metal oxide semiconductor (CMOS), power is consumed only when there is a signal, and no power is consumed when there is no signal. In particular in Non-patent Document 2, it being possible to generate a short pulse of a high frequency near the limit of a semiconductor component configuring the circuit, it is possible to generate the kind of pulse of an extremely wide band, that is, a short width, which can be used in UWB. Moreover, it is possible to make power consumption when not emitting a signal, that is, at a standby time, extremely low.

Also, the low noise amplifier circuit 1205, which is caused to operate only when there is a signal, and power consumption is extremely low at other times, is introduced in, for example, Non-patent Document 1 and Non-patent Document 3: “A 0.18 μm CMOS Switchable Low-Power LNA for Impulse Radio Ultra Wide-Band Receivers”, E. Barajas et al, Proceedings IEEE ICUWB, 2006.

FIG. 13 shows a low noise amplifier circuit 1300 of Non-patent Document 3. The low noise amplifier circuit 1300 uses two identical circuits 1311 and 1312 in order to amplify a differential signal. In the circuit 1311, N channel transistors 1301 and 1302 are an amplifier circuit formed by vertically connecting the grounded source N channel transistor 1301 and the grounded gate N channel transistor 1302, called a cascode connection, often used as a low noise amplifier circuit.

A differential signal RF+ is applied to a terminal 1308, and applied to a gate of the grounded source N channel transistor 1301 via a matching circuit formed of a capacitor 1305 and an inductor 1304. A signal amplified by the grounded source N channel transistor 1301, after being applied to the grounded gate N channel transistor 1302 gate-grounded (Bias 2) by a terminal 1306, and amplified, extracts a signal IF+ by means of a voltage drop caused by an inductor 1303.

A terminal 1309, being a terminal which applies a bias (Bias 1) to the gate of the grounded source N channel transistor 1301, applies the bias (Bias 1) via a resistor 1310. Also, although the terminal 1306 is a terminal which applies a bias (Bias 2) to a gate of the grounded source N channel transistor 1302, by controlling this bias (Bias 2), it is possible to control the current flowing into the amplifier circuit (the N channel transistors 1301 and 1302). That is, an appropriate bias voltage (Bias 2) is applied when operating the amplifier circuit, and the voltage value is made extremely low (for example, the ground potential) when there is no need to operate the amplifier circuit. As the current flowing along the path of the inductor 1303, and the N channel transistors 1302 and 1301 is zero at this time, when there is no need to operate the amplifier circuit, it is possible to stop the operation, and make the circuit current zero, by making the potential (Bias 2) applied to the terminal 1306 extremely low. In a UWB-IR, it is possible to reduce the power consumption of the low noise amplifier circuit by making the potential of the terminal 1306 extremely low when there is no signal.

In the mixer circuit 1206, although it is possible to use a normally often used double balanced mixer circuit (also referred to as a Gilbert circuit), when particularly concerned about power, it is also possible to use a passive mixer using a switch component such as a CMOS transistor.

It has been explained that, in the UWB-IR type of communication apparatus shown in FIG. 12A, it is possible to reduce the power consumption of the circuit as a whole by means of an intermittent operation technology which activates the circuit only when there is a signal. Of course, a high speed operation sufficient to handle the high frequency wideband signal of the UWB-IR is required of each circuit component configuring the communication apparatus, but in particular, a superior circuit including the high speed operation capability and an intermittent operation function has been contrived for the pulse generator circuit 1202, the template pulse generator circuit 1208, and the low noise amplifier circuit 1205. However, a circuit appropriate to this kind of operation has not existed for the mixer circuit (multiplier circuit) 1206. There are problems in that the heretofore described kind of intermittent operation is not possible with the heretofore known double balanced mixer circuit, and with the passive mixer, which does not consume power, there is little conversion gain.

Also, with the heretofore known technology, there is a problem in that the low noise amplifier circuit, the mixer, and the template pulse generator circuit, which are essential components in a UWB-IR type of communication apparatus, and in particular in a receiving apparatus thereof, are each designed individually, and have to be configured by assembling.

### SUMMARY

An advantage of some aspects of the invention is to solve at least one portion of the heretofore described problems and the invention can be realized as the following aspects or applications.

### First Application

A first application of the invention provides a mixer circuit outputs a first output signal and a second output signal, in which are mixed a first input signal and a second input signal. The mixer circuit includes a first grounded source amplifier circuit which amplifies the first input signal, a second grounded source amplifier circuit which amplifies the second input signal, a first signal output unit which outputs the first output signal, a second signal output unit which outputs the second output signal, a first transistor group including n rows and m columns (n is an integer equal to or greater than two, m is an integer equal to or greater than two) of transistors connected between the first grounded source amplifier circuit and the first signal output unit, a second transistor group including n rows and m columns of transistors connected between the first grounded source amplifier circuit and the second signal output unit, a third transistor group including n rows and m columns of transistors connected between the second grounded source amplifier circuit and the first signal output unit, a fourth transistor group including n rows and m columns of transistors connected between the second grounded source amplifier circuit and the second signal output unit, and n×m×k (k is 1 or 2) control signal lines to which n×m×k control signals which drive the first transistor group and the second transistor group, and drive the third transistor group and the fourth transistor group are input.

According to this configuration, by the first to fourth transistor groups being appropriately biased by the n×m×k control signals, it is possible to provide the mixer circuit with a function of a low noise amplifier circuit. Also, depending on a way of applying the n×m×k control signals applied to the gates of the first to fourth transistor groups, it is possible to carry out a wide variety of mixing operations. That is, when a potential such as will block the first to fourth transistor groups is included in the n×m×k control signals, by applying this potential, it is possible to block the circuit, and stop the operation. By this means, it is possible to stop the operation of the circuit when not needed, and reduce the power consumption. Also, depending on a combination of the n×m×k control signals, it is also possible to carry out an operation of inputting a signal of a frequency equivalently higher than that of the control signals. In particular, as it is possible to carry out a control of the first to fourth transistor groups using the n×m×k control signals, depending on a combination of the n×m×k control signals, an operation equivalent to inputting a signal of a frequency equivalently higher than that of the control signals is possible. In particular when handling UWB-IR signals, it is possible to equivalently synthesize them inside using the control signals, without using a UWB-IR template pulse, and carry out a multiplication of the equivalently synthesized template pulse with the input signal.

### Second Application

In the heretofore described mixer circuit, it is preferable that a potential which blocks the first transistor group, the second transistor group, the third transistor group, and the fourth transistor group is included in at least one of the n×m×k control signals.

According to this configuration, by applying a potential such as will block the first to fourth transistor groups when the circuit operation is not needed, it is possible to block the circuit, and stop the operation. By this means, it is possible to stop the operation of the mixer circuit when not needed, and reduce the power consumption. In particular when handling an intermittent signal such as the UWB-IR, it is possible to stop the circuit operation when no pulse signal is input, and reduce the power consumption.

### Third Application

In the heretofore described mixer circuit, it is preferable that the n×m×k control signals are of two values, a potential of one of the two values is a potential which blocks the first transistor group, the second transistor group, the third transistor group, and the fourth transistor group, and a potential of the other is a predetermined bias value given to the first transistor group, the second transistor group, the third transistor group, and the fourth transistor group.

According to this configuration, by applying a potential such as will block the first to fourth transistor groups when the mixer circuit operation is not needed, it is possible to block the mixer circuit, and stop the operation. Also, by making the other potential a bias value given to the first to fourth transistor groups, it is possible to make the mixer circuit a cascode amplifier circuit, by which means it is possible to provide the mixer circuit with the function of a low noise amplifier circuit in addition to the mixer function.

### Fourth Application

A fourth application of the invention provides a communication apparatus including the heretofore described mixer circuit.

According to this configuration, as the mixer circuit simultaneously has a function of a low noise amplifier circuit, a function of a mixer circuit, a wide variety of control functions using the n×m×k control signals, and a function of blocking the mixer circuit and saving on power consumption, it is possible to dramatically simplify the configuration of a communication apparatus using the mixer circuit.

### Fifth Application

A fifth application provides a communication apparatus including the heretofore described mixer circuit, receiving a UWB-IR signal, wherein the n×m×k control signals of the mixer circuit include a pulse signal wider than a template pulse of the UWB-IR signal.

According to this configuration, as it is possible, by controlling the first to fourth transistor groups with control signals wider than the template pulse of the UWB-IR with the heretofore described configuration (that is, signals of a low frequency), to equivalently generate a UWB-IR template signal in the mixer circuit, it becomes unnecessary to input a high frequency wideband signal, like the UWB-IR template pulse, into the mixer circuit. Furthermore, as the mixer circuit simultaneously has a function of a low noise amplifier circuit, a function of a mixer circuit, a function of synthesizing a template signal using the control signals, and a function of blocking the mixer circuit and saving on power consumption, it is possible to dramatically simplify the configuration of a communication apparatus using the mixer circuit. This is particularly effective in a communication apparatus, such as a UWB-IR, which handles an intermittent signal.

### Sixth Application

A sixth application of the invention provides a communication apparatus including the heretofore described mixer circuit, wherein the n×m×k control signals of the mixer circuit including at least a signal having a component of a frequency f₁, and a signal having a component of a frequency f₂, a frequency fᵣ of a received signal coincides with either a sum of, or a difference between, the frequency f₁ and the frequency f₂.

According to this configuration, as the mixer circuit simultaneously has a function of a low noise amplifier circuit, a function of a mixer circuit, a wide variety of control functions using the control signals, and a function of blocking the mixer circuit and saving on power consumption, it is possible to dramatically simplify the configuration of a communication apparatus using the mixer circuit. In particular, when using a signal having two frequency components, the frequencies f₁ and f₂, as the control signal, it is possible to obtain a signal of fᵣ−(f₁±f₂) in the output signal. As such, when choosing (f₁+f₂) or (f₁−f₂) in such a way as to coincide with fᵣ, it is possible to convert a frequency of the received signal directly to baseband. By this means, a receiving apparatus configuration using a direct conversion is possible, on top of which, as a local oscillator frequency with the same frequency as the received signal is not used, it is possible to avoid a DC offset, which is a problem in the heretofore known direct conversion type of receiving apparatus.

### BRIEF DESCRIPTION OF THE DRAWINGS

The invention will be described with reference to the accompanying drawings, wherein like numbers reference like elements.

FIG. 1 is a circuit diagram showing a configuration of a mixer circuit according to a first embodiment.

FIG. 2 is a timing diagram illustrating an operation of the mixer circuit according to the first embodiment.

FIG. 3 is a circuit diagram showing a configuration of a logic circuit which generates control signals applied to the mixer circuit.

FIG. 4 is a timing diagram illustrating an operation of the logic circuit which generates the control signals applied to the mixer circuit.

FIG. 5 is a circuit diagram showing the configuration of the logic circuit which generates the control signals applied to the mixer circuit.

FIG. 6 is a circuit diagram illustrating a mixer circuit according to a second embodiment.

FIG. 7 is a circuit diagram illustrating another example of the mixer circuit according to the second embodiment.

FIGS. 8A and 8B are circuit diagrams illustrating a mixer circuit according to a third embodiment.

FIG. 9 is a timing diagram illustrating an operation of a circuit which generates control signals applied to the mixer circuit according to the third embodiment.

FIGS. 10A and 10B show a UWB-IR communication apparatus configured using a mixer circuit according to a fourth embodiment.

FIG. 11 shows a receiver configured using a mixer circuit according to a fifth embodiment.

FIGS. 12A, 12B and 12C are a block diagram and timing diagrams illustrating a heretofore known UWB-IR communication apparatus.

FIG. 13 shows a heretofore known low noise amplifier circuit.

### DESCRIPTION OF EXEMPLARY EMBODIMENTS

Hereafter, a description will be given, in accordance with the drawings, of embodiments of a mixer circuit.

### First Embodiment

Configuration of Mixer Circuit

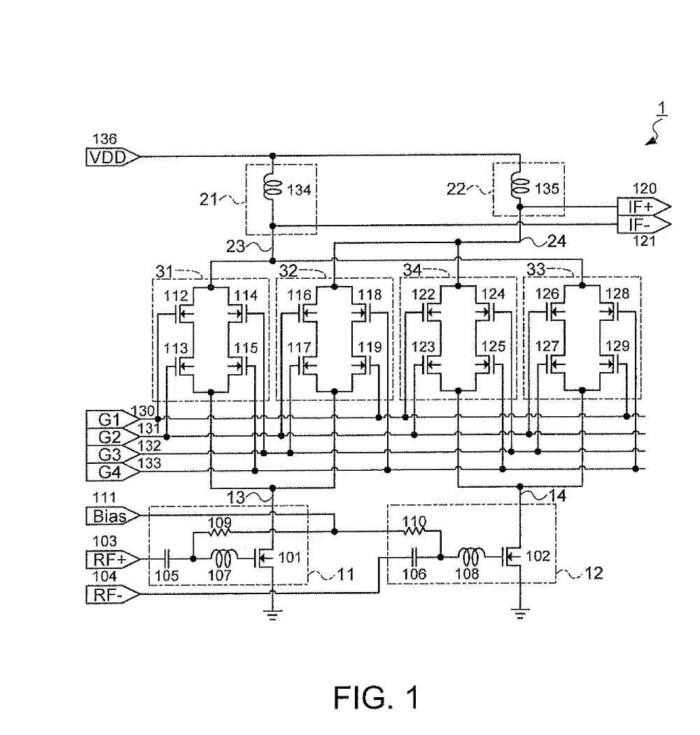

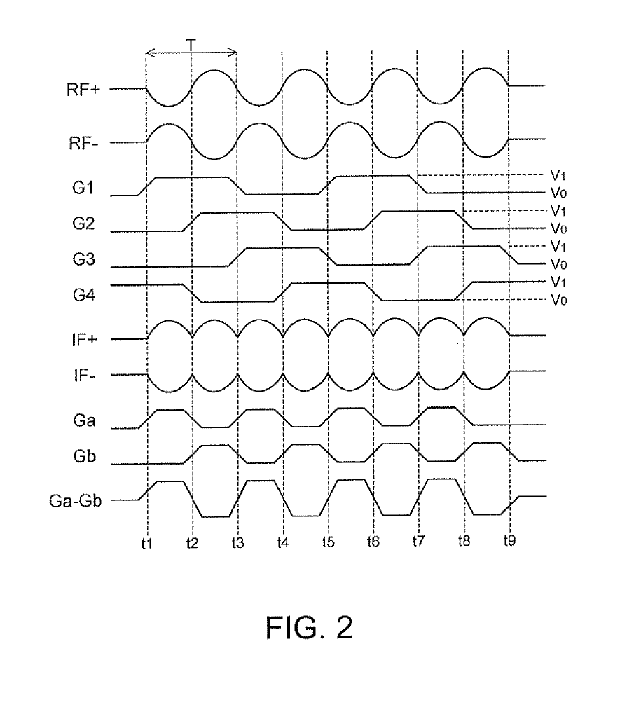

Firstly, a description will be given, referring to FIGS. 1 and 2, of configuration of a mixer circuit according to a first embodiment. FIG. 1 is a circuit diagram showing a configuration of the mixer circuit according to the first embodiment. FIG. 2 is a timing diagram showing an operation of the mixer circuit according to the first embodiment.

As shown in FIG. 1, the mixer circuit 1 is configured of a grounded source amplifier circuit 11, which is a first grounded source amplifier circuit, a grounded source amplifier circuit 12, which is a second grounded source amplifier circuit, a signal output unit 21, which is a first signal output unit, a signal output unit 22, which is a second signal output unit, a transistor group 31, which is a first transistor group, a transistor group 32, which is a second transistor group, a transistor group 33, which is a third transistor group, and a transistor group 34, which is a fourth transistor group.

The grounded source amplifier circuit 11 is configured of an N channel transistor 101, of which a source terminal is grounded and a drain terminal is connected to a wire 13, a capacitor 105, an inductor 107, and a resistor 109. The capacitor 105 and the inductor 107 are connected in series between an input terminal 103 and a gate terminal of the N channel transistor 101. The resistor 109 is connected between a wire connecting the capacitor 105 and inductor 107, and an input terminal 111. A differential signal RF+, which is a first input signal, is input into the input terminal 103.

The grounded source amplifier circuit 12 is configured of an N channel transistor 102, of which a source terminal is grounded and a drain terminal is connected to a wire 14, a capacitor 106, an inductor 108, and a resistor 110. The capacitor 106 and the inductor 108 are connected in series between an input terminal 104 and a gate terminal of the N channel transistor 102. The resistor 110 is connected between a wire connecting the capacitor 106 and inductor 108, and the input terminal 111. A differential signal RF−, which is a second input signal, is input into the input terminal 104.

A bias voltage Bias is supplied to the input terminal 111. The bias voltage Bias is applied to the gate terminal of the N channel transistor 101 via the resistor 109 and inductor 107. Also, the bias voltage Bias is applied to the gate terminal of the N channel transistor 102 via the resistor 110 and inductor 108.

The signal output unit 21 is configured of an inductor 134 connected between a power source terminal 136, which applies a power source voltage VDD, and a wire 23. An output terminal 121, outputting an output signal IF− which is a first output signal, is connected to the wire 23.

The signal output unit 22 is configured of an inductor 135 connected between the power source terminal 136 and a wire 24. An output terminal 120, outputting an output signal IF+ which is a second output signal, is connected to the wire 24.

The transistor group 31 is configured of N channel transistors 112, 113, 114, and 115 in (n=) 2 rows and (m=) 2 columns. The N channel transistors 112 and 113 are connected in series between the wire 23 and the wire 13. The N channel transistors 114 and 115 are connected in series between the wire 23 and the wire 13. A gate terminal of the N channel transistor 112 is connected to a control signal line 130. A gate terminal of the N channel transistor 113 is connected to a control signal line 131. A gate terminal of the N channel transistor 114 is connected to a control signal line 132. A gate terminal of the N channel transistor 115 is connected to a control signal line 133.

The transistor group 32 is configured of N channel transistors 116, 117, 118, and 119 in 2 rows and 2 columns. The N channel transistors 116 and 117 are connected in series between the wire 24 and the wire 13. The N channel transistors 118 and 119 are connected in series between the wire 24 and the wire 13. A gate terminal of the N channel transistor 116 is connected to the control signal line 131. A gate terminal of the N channel transistor 117 is connected to the control signal line 132. A gate terminal of the N channel transistor 118 is connected to the control signal line 133. A gate terminal of the N channel transistor 119 is connected to the control signal line 130.

The transistor group 33 is configured of N channel transistors 126, 127, 128, and 129 in 2 rows and 2 columns. The N channel transistors 126 and 127 are connected in series between the wire 23 and the wire 14. The N channel transistors 128 and 129 are connected in series between the wire 23 and the wire 14. A gate terminal of the N channel transistor 126 is connected to the control signal line 131. A gate terminal of the N channel transistor 127 is connected to the control signal line 132. A gate terminal of the N channel transistor 128 is connected to the control signal line 133. A gate terminal of the N channel transistor 129 is connected to the control signal line 130.

The transistor group 34 is configured of N channel transistors 122, 123, 124, and 125 in 2 rows and 2 columns. The N channel transistors 122 and 123 are connected in series between the wire 24 and the wire 14. The N channel transistors 124 and 125 are connected in series between the wire 24 and the wire 14. A gate terminal of the N channel transistor 122 is connected to the control signal line 130. A gate terminal of the N channel transistor 123 is connected to the control signal line 131. A gate terminal of the N channel transistor 124 is connected to the control signal line 132. A gate terminal of the N channel transistor 125 is connected to the control signal line 133.

(n×m×k=2×2×1=) 4 control signals G1, G2, G3, and G4 are input into the control signal lines 130, 131, 132, and 133 respectively. The control signals G1, G2, G3, and G4 are input into gates of the transistors constituting the transistor groups 31 and 32, and into gates of the transistors constituting the transistor groups 33 and 34 to drive these transistors.

In the embodiment, showing a case of a UWB-IR signal, a pulse train with a period T, and a number of pulse fingers equaling four periods, is given as an example of the differential signals RF+ and RF−, as shown in FIG. 2. The kinds of differential signals RF+ and RF− shown in FIG. 2 can be obtained in, for example, a case of receiving the heretofore mentioned UWB-IR signal with a balanced type antenna. The differential signals RF+ and RF− are applied respectively to the gate terminals of the N channel transistors 101 and 102 via input matching circuits formed by the capacitors 105 and 106, and the inductors 107 and 108.

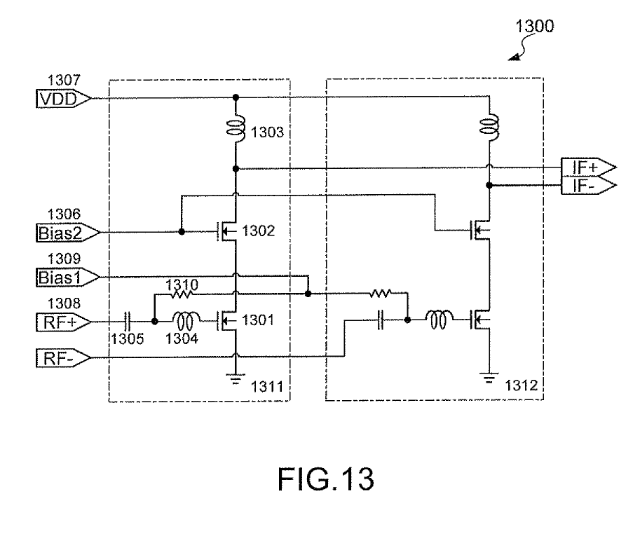

It is possible to view the N channel transistors 112 and 113 connected in series as being one transistor, whose channel length is L1+L2 in the event that an identical voltage is applied to each gate terminal. Herein, L1 and L2 are the channel lengths of the N channel transistors 112 and 113 respectively. Thinking of the N channel transistors 112 and 113 connected in series as being one transistor, in the event that the drain terminal of the N channel transistor 101 is viewed as being connected to it, the N channel transistors 112, 113 and 101 can be taken to be a heretofore known cascode connection shown in FIG. 13.

Apart from the N channel transistors 112 and 113, the N channel transistors 114 and 115, the N channel transistors 116 and 117, and the N channel transistors 118 and 119, connected in series, are connected in parallel to the N channel transistor 101. The gate terminals of the eight N channel transistors 112 to 119 are controlled by the control signals G1, G2, G3, and G4, input into the control signal lines 130, 131, 132, and 133, by means of the kind of connection shown in FIG. 1.

The kinds of control signal G1, G2, G3, and G4 shown in FIG. 2 are input into the control signal lines 130, 131, 132, and 133 respectively. The control signals G1 to G4 taking two values, a minimum value V₀ and a maximum value V₁, they change over a short transition time in the kind of sequence shown in FIG. 2. The way in which these kinds of signal are made will be described hereafter. Also, for the sake of subsequent description, a point at which each signal transits is defined as t1, t2, and so on to t9, as in FIG. 2. In FIG. 2, only a portion in which an intermittent UWB-IR signal exists is enlarged and depicted. Actually, times up to the point t1 and from the point t9 on, in which there is no signal, are far longer than the period of the points t1 to t9.

Now, the minimum value V₀ is taken to be the kind of low voltage value which blocks the N channel transistors 112 to 119, and the N channel transistors 122 to 129, in FIG. 1, and the maximum value V₁ is taken to be a gate bias value in the event of viewing the N channel transistors 112 to 119, and 122 to 129, connected in series, as one grounded gate stage transistor. By choosing the minimum value V₀ and the maximum value V₁ in this way, the N channel transistors 112 and 113 operate as the grounded gate stage in a period from the point t2 to t3, and a period from the point t6 to t7, during which the control signals G1 and G2 both attain the maximum value V₁, as shown in FIG. 2. In the same way, the N channel transistors 114 and 115 operate as the grounded gate stage in a period from the point t4 to t5, and a period from the point t8 to t9, during which the control signals G3 and G4 both attain the maximum value V₁, also, the N channel transistors 126 and 127 operate as the grounded gate stage in a period from the point t3 to t4, and a period from the point t7 to t8, during which the control signals G2 and G3 both attain the maximum value V₁, and the N channel transistors 128 and 129 operate as the grounded gate stage in a period from the point t1 to t2, and a period from the point t5 to t6, during which the control signals G1 and G4 both attain the maximum value V₁.

For this reason, a signal (inversely) amplified by the N channel transistor 102, and further amplified by the grounded gate stage formed by the N channel transistors 128 and 129, in the period from the point t1 to t2 is detected in the inductor 134. Also, in the same way, a signal amplified by the N channel transistor 101, and further amplified by the N channel transistors 112 and 113 connected in series, in the period from the point t2 to t3 is detected in the inductor 134. Hereafter, in the same way, the drain output of the N channel transistors 101 and 102 switches every half period T, a signal amplified by a grounded gate stage formed by series transistors is detected in the inductor 134, and transmitted to the output terminal 121 as an output signal IF−.

Meanwhile, in the inductor 135, by means of a connection complementary to that heretofore described, that is, by subjecting the drain output of the N channel transistor 101 to a grounded gate amplification by the N channel transistors 116 and 117 in the period from the point t3 to t4, and the period from the point t7 to t8, and also, by the N channel transistors 118 and 119 in the period from the point t1 to t2, and the period from the point t5 to t6, and furthermore, by subjecting the drain output of the N channel transistor 102 to a grounded gate amplification by the N channel transistors 122 and 123 in the period from the point t2 to t3, and the period from the point t6 to t7, and also, by the N channel transistors 124 and 125 in the period from the point t4 to t5, and the period from the point t8 to t9, the drain outputs are transmitted to the output terminal 120 as an output signal IF+.

To summarize the above, when applying the maximum value V₁ and the minimum value V₀ respectively to a true value and a false value of a binary signal, when the logical expression Ga=G1×G4+G2×G3 is true, the differential signal RF+ input into the input terminal 103 is transmitted, (inversely) amplified, to the output terminal 120, and also, the differential signal RF− input into the input terminal 104 is transmitted, (inversely) amplified, to the output terminal 121. Also, when the logical expression Gb=G1×G2+G3×G4 is true, the differential signal RF− input into the input terminal 104 is transmitted, (inversely) amplified, to the output terminal 120, and also, the differential signal RF+ input into the input terminal 103 is transmitted, amplified, to the output terminal 121. When neither of the two logical expressions Ga and Gb is true, that is, up to the point t1 or from the point t9 on, the mixer circuit 1 is blocked, and no power is consumed. This means that a product of multiplying a difference Ga−Gb of the binary signal according to the two logical expressions Ga and Gb, and the differential signals RF+ and RF−, is being output.

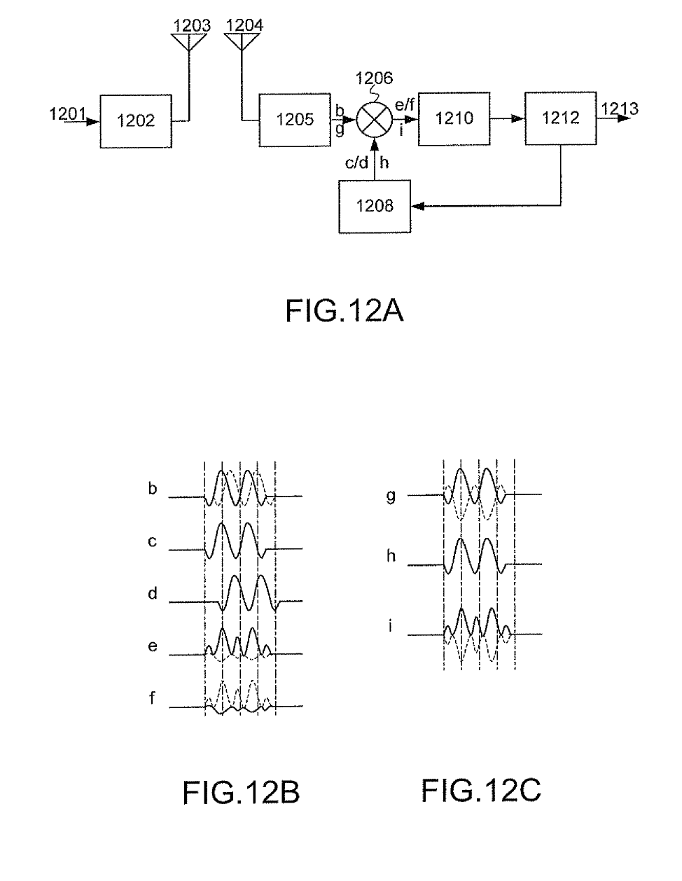

By setting the control signals G1 to G4 as in FIG. 2, the difference Ga−Gb of the binary signal of FIG. 2 being of a value equivalent to that of a template signal used in UWB-IR communication, it is possible to provide one portion of functions as a low noise amplifier circuit, a multiplier circuit, and a template pulse generator circuit, with the mixer circuit 1. That is, it is possible to use the mixer circuit 1 in place of one portion of a low noise amplifier circuit 1205, a multiplier circuit 1206, and a template pulse generator circuit 1208, in the heretofore known UWB-IR reception mechanism configuration diagram shown in FIG. 12A. With the mixer circuit 1 of the embodiment, there is no need to supply a template pulse from the exterior. In UWB-IR communication, the template pulse used as the template signal is of an extremely high speed, and frequently reaches a level of a limit frequency of a component configuring an instrument, but with the mixer circuit 1 of the embodiment, there is no need to generate this kind of high speed signal. Also, as the mixer circuit 1 of the embodiment does not consume power when there is no template pulse, there is no need for a heretofore known kind of switch circuit which controls the turning on and off of the circuit power.

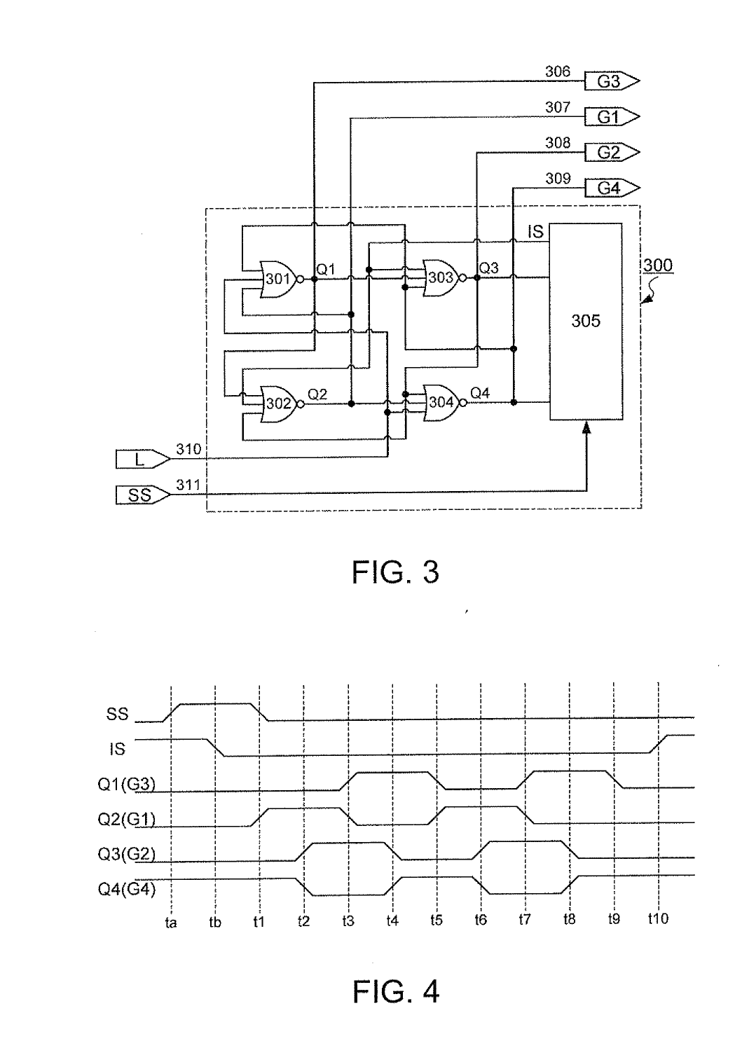

FIG. 3 is one example of a logic circuit 300 which generates the heretofore described control signals G1 to G4, while FIG. 4 is a timing diagram of the logic circuit 300 which generates the control signals G1 to G4. Hereafter, for the sake of the description, outputs of negative OR circuits (NOR) 301, 302, 303, and 304 are taken to be Q1, Q2, Q3, and Q4 respectively and, in order to express a condition of an output value of each of these, for example, (Q1, Q2, Q3, Q4)=(L, L, H, H) or simply (LLHH) will be written. This expresses the fact that the output values of the NOR 301 and 302 are false, and the output values of the NOR 303 and 304 are true.

A control circuit 305 receives a start-up signal SS, shown in FIG. 4, input into a terminal 311, and generates an initialization signal IS for initializing the logic circuit 300. Also, “false” (L) will invariably be input into a terminal 310. Although it is also acceptable that the NOR 301 and 304 are 2-input NOR, 3-input NOR are connected in order to maintain symmetry with the NOR 302 and 303. In the logic circuit 300, the NOR 301 output signal Q1 is Q1=X(Q2+Q4), the NOR 302 output signal Q2 is Q2=X(Q1+Q3+IS), the NOR 303 output signal Q3 is Q3=X(Q1+Q4+IS), and the NOR 304 output signal Q4 is Q4=X(Q2+Q3). Herein, X being a reference letter expressing a logical negation, it preposes a logical expression or a logical value, expressing a negation of the logic thereof.

Hereafter, a description will be given of an operation of the logic circuit 300 of FIG. 3, while referring to the timing diagram of FIG. 4.

Firstly, in a static condition up to a point tb, the initialization signal IS generated by the control circuit 305 is H, so (Q2, Q3)=(L, L). As such, (Q1, Q4)=(L, H). That is, up to the point tb, a condition wherein (Q1, Q2, Q3, Q4)=(L, L, L, H) is maintained.

On the start up signal SS rising at a point ta, the control circuit 305, in response to this, causes the initialization signal IS to fall in order to operate the circuit. That is, with a delay from the point ta, the control circuit 305 causes a change to IS=L at the point tb.

When the initialization signal IS=L, the NOR 301 and NOR 302 form an RS flip flop circuit. The NOR 303 and NOR 304 are also forming an RS flip flop circuit in the same way, as they are connected in such a way that positive feedback is achieved, the logic circuit 300 begins to oscillate. That is, with the delay of the NOR circuit operation, Q1, Q2, Q3, and Q4 change, from a point t1 on, in the way (LHLH)→(LHHL)→(HLHL)→(HLLH). The control circuit 305, monitoring Q3 or Q4, can stop the oscillation, and return to the initial static condition, by making the initialization signal IS=H when the number of pulse fingers reaches a predetermined value.

The output signals Q1, Q2, Q3 and Q4 become the control signals G1, G2, G3 and G4 of FIG. 1 by correlating as G1=Q2, G2=Q3, G3=Q1 and G4=Q4. A template pulse created by synthesizing the output signals Q1, Q2, Q3 and Q4 generated by the logic circuit 300 can be set to a transition time determined by an amount of delay of the NOR 301 to 304. Although it is compatible with the kind of short template pulse which can be used in UWB-IR communication, the control signals G1, G2, G3 and G4 being signals of a considerably lower speed than the template pulse, this makes the circuit configuration of the logic circuit 300 extremely easy. With regard to a frequency adjustment in the event of using as a template pulse, it is possible to adjust to a desired frequency by a method such as controlling the power source voltage of the NOR 301 to 304, or adding a small amount of capacitance, which becomes a load on the output, and adjusting the amount of load.

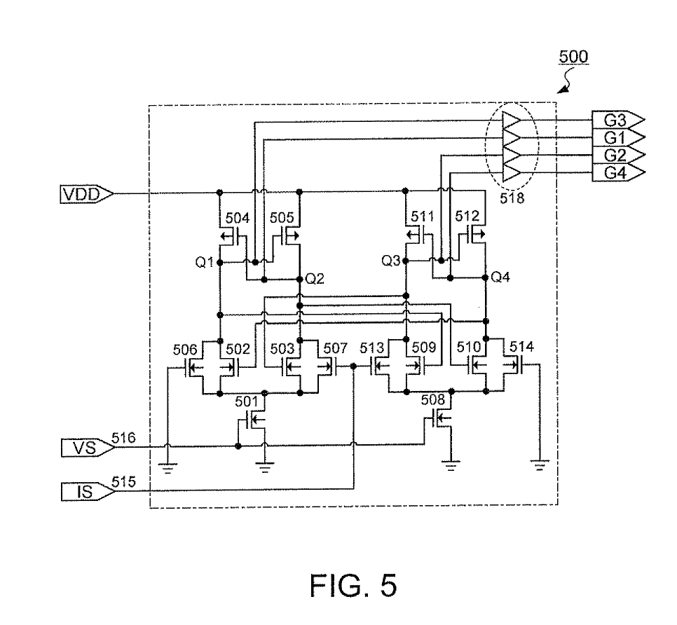

FIG. 5 shows one example of another logic circuit 500 which generates the control signals G1 to G4. In FIG. 5, a differential amplifier circuit is formed by transistors 501, 502, 503, 504, and 505. The N channel transistor 501 limits the circuit current by forming a current source which limits the circuit current. A response time of the differential amplifier circuit changing in accordance with this control of the circuit current, it is possible to control an amount of delay in transmitting a signal. That is, it is possible to control a pulse width of a signal generated, in accordance with a voltage VS applied from a terminal 516, in a gate of the N channel transistor 501.

The P channel transistors 504 and 505 being a load of a differential amplifier stage formed by the N channel transistors 502 and 503, the gates of the P channel transistors 504 and 505 are connected to each other's drains, forming a so-called cross-couple circuit. This connection emphasizes a reciprocal change, and minimizes a signal transition slip. An N channel transistor 507 being a switch for setting an initial condition, it is possible to switch between the initial condition and an operational condition by means of an initialization signal IS applied to a terminal 515. That is, when a potential of the initialization signal IS is high, the N channel transistor 507 is compulsorily turned on, a drain potential (Q2) of the P channel transistor 505 compulsorily becomes L, and the logic circuit 500 is set to the initial condition. Also, when the potential of the initialization signal IS is low, the N channel transistor 507 is turned off, and the logic circuit 500 attains the operational condition. An N channel transistor 506, its gate potential being consistently set to a ground potential, is consistently turned off. Although the N channel transistor 506 has no direct effect on the operation, it is added in order to obtain a good equilibrium (symmetry) of the differential amplifier operation.

The circuit formed by the transistors 508 to 514, in the same way as the heretofore described circuit formed by the transistors 501 to 507, configures a differential amplifier circuit. By cascade connecting the two differential amplifier circuits, making the kind of connection shown in FIG. 5, on returning the output to the input side so that positive feedback is achieved, an oscillator circuit having a four phase output is formed. By controlling the initialization signal IS, applied to the terminal 515, by means of the same kind of operation as that of the circuit of FIG. 3, it is possible to obtain the heretofore described control signals G1, G2, G3, and G4. That is, taking the drain output signals of the transistors 504, 505, 511, and 512 to be Q1, Q2, Q3, and Q4, by buffer amplifying and removing each of them by means of a buffer 518, they become the control signals G3, G1, G2, and G4 respectively.

According to the heretofore described embodiment, the following benefits can be obtained.

With the mixer circuit 1 of the embodiment, when the circuit operation is not necessary, an intermittent operation which blocks the mixer circuit 1 is possible by means of the control signals (G1 to G4) applied to the transistors connected in series. By this means, by using the mixer circuit 1 in a communication apparatus, such as a UWB-IR utilizing an intermittent signal, it is possible to reduce a power consumption of the apparatus as a whole.

Also, with the mixer circuit 1 of the embodiment, as it is also possible to view it as a circuit wherein a mixer is embedded in a grounded gate stage in a cascode connection of a low noise amplifier circuit, it is possible to provide it with a function of a low noise amplifier circuit, in addition to a mixer function. Moreover, as opposed to a heretofore known low noise amplifier circuit and mixer circuit, wherein the currents flow from the power source separately, with the mixer circuit 1, the currents flow along one path. For this reason, it is possible to reduce the power consumed in the circuit in comparison with that in the circuit configuration according to the heretofore known technology.

Furthermore, as opposed to the heretofore known case wherein a template waveform is input into a mixer, and a multiplication with a received signal is carried out, with the mixer circuit 1, template pulses are synthesized by a logic synthesis of the grounded gate stage. For this reason, there being no need to input a template pulse into the mixer circuit 1, it is sufficient to input a signal of a frequency far lower than that of a template pulse. That is, there is no need to generate a template pulse for inputting into the mixer circuit 1. By this means, a circuit design is made extremely easy in a case such as a UWB-IR, which has to handle a template pulse of the kind of high frequency near the limit of a circuit component.

Also, in a configuration of a heretofore known UWB-IR receiver, a template pulse input into a mixer is required to have a large amplitude, for which reason a drive circuit, which amplifies a template pulse generated in an appropriate template pulse generator circuit, is needed. Although the design of these circuits presents difficulty because the frequency handled is high, as it is possible in the embodiment to synthesize the template pulses by means of a combination of the control signals input into the mixer circuit 1, it is sufficient that the signal input into the mixer circuit 1 is a signal of a frequency considerably lower than the frequency of a template pulse, and the design is easy. It being possible to omit a circuit such as the drive circuit which is necessary with the heretofore known technology, this enables a still further reduction in power consumption.

Furthermore, when configuring a so-called direct conversion type of receiver which reduces a received signal directly to a baseband using a heretofore known mixer circuit, there is a serious problem in that a so-called DC offset occurs whereby a local signal generated by a local oscillator leaks on a wireless signal (differential signal RF) side, the signal is reflected due to a circuit mismatch or the like, and is converted into a direct current component by its own local signal. With the mixer circuit 1 of the embodiment, as it is possible to arrange in such a way that a signal corresponding to the local signal does not have the same frequency component as the wireless signal, a problem such as the heretofore described kind of DC offset does not occur. The mixer circuit 1 of the embodiment is also considerably effective in communication using a heretofore known narrowband signal.

### Second Embodiment

Next, a description will be given of a second embodiment of a mixer circuit. In the first embodiment, using the inductors 134 and 135 in the signal output units 21 and 22, an amplified current signal is converted to a voltage and extracted. In general, when using the mixer circuit (multiplier circuit) in a frequency conversion as a multiplier circuit used in a UWB-IR or as a receiver mixer circuit, the frequency of the extracted signal is low in comparison with the input signal. In this kind of case, when attempting to extract the signal by means of the inductor, an inductance with a large value is needed. In a case such as when forming an inductance on an integrated circuit, it being difficult to mount a large inductance which can take a sufficient amplitude value, it can happen that the signal amplitude becomes smaller in such a case.

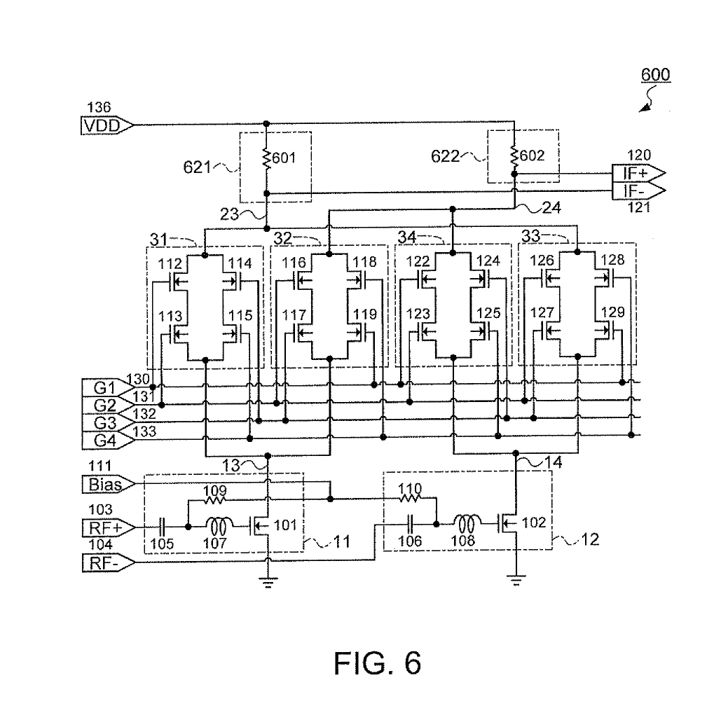

In the second embodiment, two examples corresponding to the heretofore described kind of case will be shown. FIG. 6 is an example of a mixer circuit 600, using signal output units 621 and 622 to which are connected resistors 601 and 602 in place of the inductors 134 and 135 of FIG. 1. By configuring in this way, the mixer circuit 600 can also extract a low frequency component signal, regardless of the inductance value. In the mixer circuit 600 of FIG. 6, in order to extract a large signal, a large voltage drop is brought about by the resistors 601 and 602. For this reason, when attempting to obtain a large signal, it is necessary to increase the power source voltage VDD.

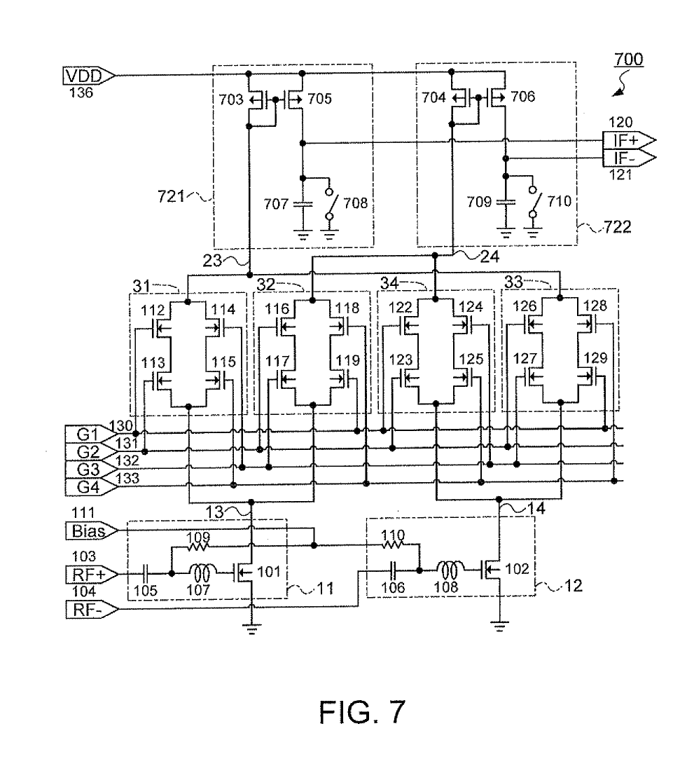

FIG. 7 is an example of a mixer circuit 700, using signal output units 721 and 722 in place of the signal output units 21 and 22 of FIG. 1. The mixer circuit 700 can extract a large signal without a large voltage drop. P channel transistors 703 and 704, being diode connected, configure current mirror circuits with P channel transistors 705 and 706 respectively. That is, signal currents detected by the P channel transistors 703 and 704 are copied and output by the P channel transistors 705 and 706. As these current mirror circuits, being a current source, have a sufficiently high impedance, a design of an integrating circuit connected to a subsequent stage for configuring a correlation circuit is easy. That is, a sufficient performance is obtained simply by connecting capacitors 707 and 709 as in the figure. Switches 708 and 710 are reset switches for releasing a charge loaded into the capacitors at the start of integration, and returning to the initial condition.

### Third Embodiment

Next, a description will be given of a third embodiment of a mixer circuit. In the first embodiment, the case is shown in which the transistor groups 31 to 34 are configured of 2 rows and 2 columns of transistors. By increasing the transistors in the transistor groups 31 to 34, it is possible to lengthen the pulse width of the control signals. By this means, the control signal frequency component becomes lower, and the circuit design becomes easier. In the third embodiment, a description will be given of a mixer circuit 800 which uses transistor groups 831 to 834 configured of 2 rows and 4 columns of transistors. With the mixer circuit 800, as an example, a multiplication of the same kind of four pulse finger template pulse as in the first embodiment is possible but, not being limited to this case, it is possible to detect a pulse with more pulse fingers by increasing the number of grounded gate stages.

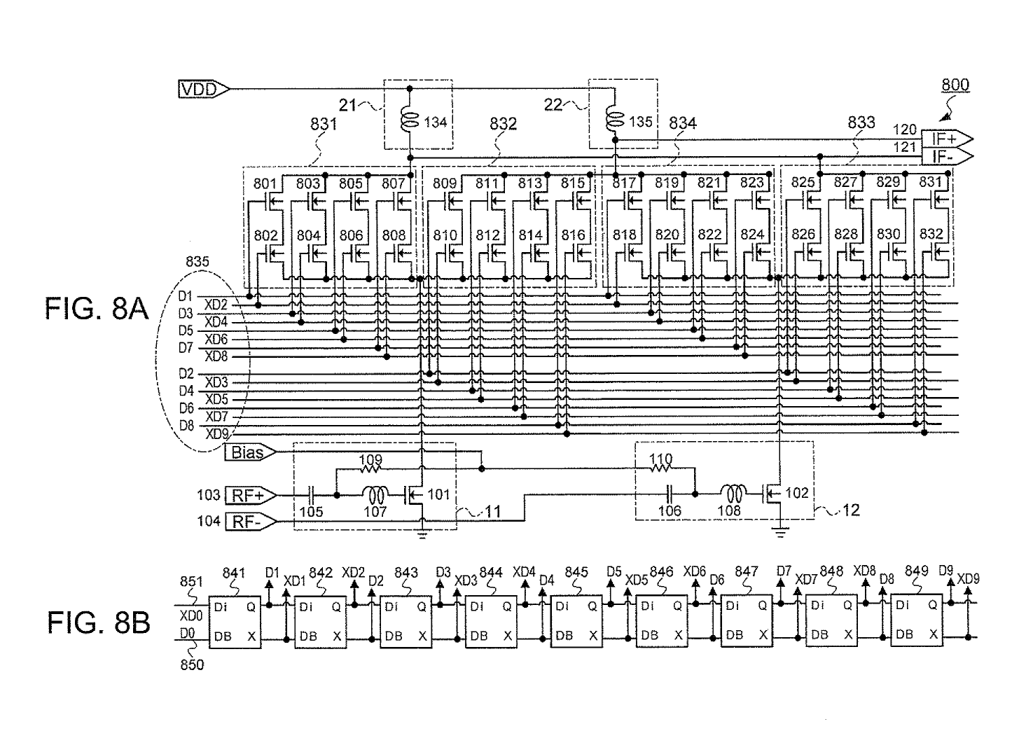

FIG. 8A being the mixer circuit 800 of the third embodiment, FIG. 8B is an illustration of a circuit for generating a control signal. In FIG. 8A, being the same as FIG. 1 minus the grounded gate stage formed by the series transistors, for the sake of simplification, areas which operate in the same way as the circuit of FIG. 1 will be given the same numerals as in FIG. 1, and a description will be omitted.

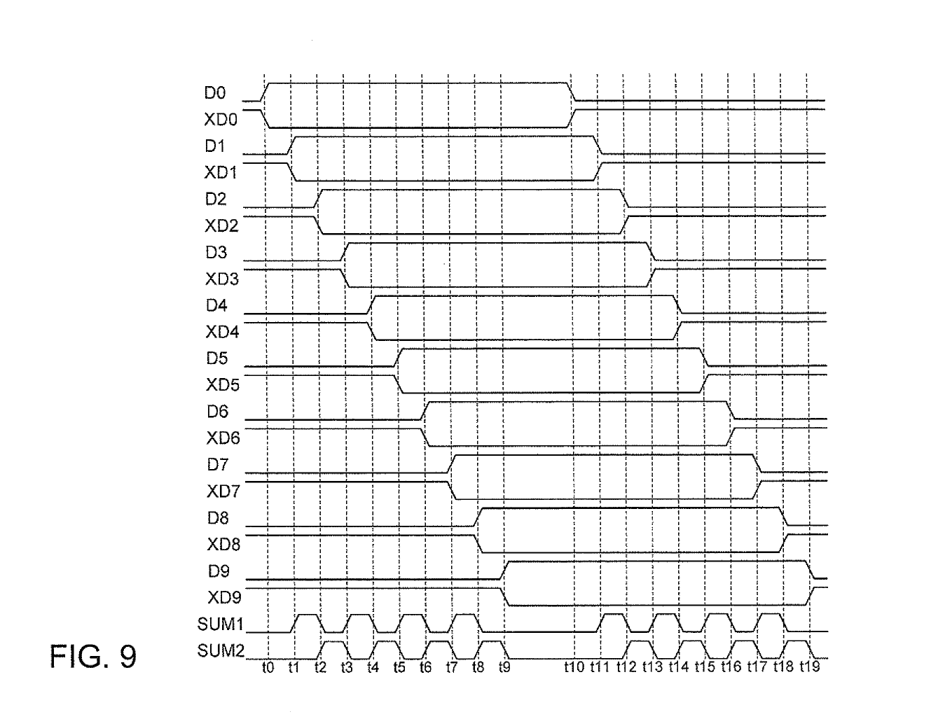

In FIG. 8A, a group of terminals surrounded by a dashed-dotted line oval 835, being terminals which input (n×m×k=2×4×2=) 16 control signals D1 to D8 and XD2 to XD9, are connected respectively to gates of transistors 801 to 832 of a grounded gate stage in accordance with rules to be explained hereafter. A description will be given hereafter, referring to FIG. 8B, of a method of generating the control signals D1 to D8 and XD2 to XD9. Also, FIG. 9 shows a timing diagram for a supplementary description of the control signals D1 to D8 and XD2 to XD9, and of operations thereof.

The N channel transistors 801 to 808 of the transistor group 831 subject a signal amplified by the grounded source stage N channel transistor 101 to a grounded gate amplification, and output it to the output terminal 121 by means of the inductor 134.

The N channel transistors 809 to 816 of the transistor group 832 subject a signal amplified by the grounded source stage N channel transistor 101 to a grounded gate amplification, and output it to the output terminal 120 by means of the inductor 135.

The N channel transistors 817 to 824 of the transistor group 834 subject a signal amplified by the grounded source stage N channel transistor 102 to a grounded gate amplification, and output it to the output terminal 120 by means of the inductor 135.

The N channel transistors 825 to 832 of the transistor group 833 subject a signal amplified by the grounded source stage N channel transistor 102 to a grounded gate amplification, and output it to the output terminal 121 by means of the inductor 134.

Taking the control signals D1 to D8 and XD2 to XD9 to have two values, a minimum value V₀ and a maximum value V₁, in the same way as in the description in the first embodiment, when viewing these as logical values, the N channel transistors 801 and 802 operate as a grounded gate amplifier circuit when a logical product of the control signals D1 and XD2 is true, and are blocked at other times. The other N channel transistors 803 to 808 of the transistor group 831 forming three series pairs, each pair operates as a grounded gate amplifier circuit when logical products of D3 and XD4, D5 and XD6, and D7 and XD8 are true, and is blocked at other times. That is, the transistor group 831 operates as a grounded gate amplifier circuit when a logical product of D₋₁ and XDᵢ is true, when is taken to be an even number, and is blocked at other times.

The N channel transistors 817 to 824 of the transistor group 834, being connected in exactly the same way as the N channel transistors 801 to 808 of the transistor group 831, operate as a grounded gate amplifier circuit when the logical product of D₋₁ and XDᵢ is true, and are blocked at other times.

The N channel transistors 809 to 816 of the transistor group 832, and the N channel transistors 825 to 832 of the transistor group 833, operate as a grounded gate amplifier circuit when a logical product of Dᵢ and XDᵢ₊₁ is true, and are blocked at other times.

Consequently, when the logical product of D₋₁ and XDᵢ is true, a signal subjected to a grounded source amplification by the N channel transistor 101 is subjected to a grounded gate amplification by the N channel transistors 801 to 808 of the transistor group 831, and output to the output terminal 121. Also, at this time, a signal subjected to a grounded source amplification by the N channel transistor 102 is subjected to a grounded gate amplification by the N channel transistors 817 to 824 of the transistor group 834, and output to the output terminal 120.

When the logical product of Dᵢ and XDᵢ₊₁ is true, a signal subjected to a grounded source amplification by the N channel transistor 101 is subjected to a grounded gate amplification by the N channel transistors 809 to 816 of the transistor group 832, and output to the output terminal 120. Also, at this time, a signal subjected to a grounded source amplification by the N channel transistor 102 is subjected to a grounded gate amplification by the N channel transistors 825 to 832 of the transistor group 833, and output to the output terminal 121.

On taking a sum (a logical sum) of every case of i=2 to 8 for the logical product of D₋₁ and XDᵢ, and the logical product of Dᵢ and XDᵢ₊₁, they are as SUM1 and SUM2 in FIG. 9. When viewing the two signals SUM1 and SUM2 as differential signals, they are template signals used in a UWB-IR.

By appropriately generating the control signals D1 to D8, and XD2 to XD9, according to the above operation description, and arranging in such a way that the signals generated by the logical product of D₋₁ and XDᵢ, and the logical product of Dᵢ and XDᵢ₊₁, thereof become a template pulse, the template pulse, and the result of carrying out a multiplication after amplifying the differential signals RF+ and RF− applied to the input terminals 103 and 104, are obtained at the mixer circuit 800 output terminals 120 and 121.

Hereafter, a description will be given of a method of generating the control signals D1 to D8, and XD2 to XD9, referring to the logic circuit of FIG. 8B, and to the timing diagram of FIG. 9 showing the operation.

Delay circuits 841 to 849 are differential type delay circuits. The delay circuits 841 to 849, being delay circuits which differentially output a differential signal with a predetermined delay, can use the flip flop circuit configured by the NOR 301 and 302 (or 303 and 304) of FIG. 3, the differential amplifier circuit formed by the transistors 501 to 505 (or 508 to 512) of FIG. 5, or the like. Also, a circuit wherein outputs of current limited inverters are united by a cross coupled inverter, or the like, is also often used.

Now, on inputting D0 and XD0 into the delay circuit 841 as start-up signals, control signals XD1 and D1 are output with a predetermined delay (FIG. 9). Thereafter, signals are output sequentially, with a delay, by the delay circuits 842 to 849, and D2 to D9, and XD2 to XD9, are output. With the mixer circuit 800 of the third embodiment, XD1 and D9 are not used.

On taking the sum (the logical sum) of every case of i=2 to 8 for the logical product of D₋₁ and XDᵢ, and the logical product of Dᵢ and XDᵢ₊₁, they are as SUM1 and SUM2 in FIG. 9. The two waveforms being a four pulse fingered pulse used in a UWB-IR when viewed as differential signals, by controlling a delay amount of the delay circuits 841 to 849, causing them to coincide with a period of a pulse used in a UWB-IR, they become a template waveform used in the UWB-IR. In the first embodiment, the control circuit 305, which counts the fingers in order to regulate the number of pulse fingers, is needed, but in the third embodiment, as the number of pulse fingers is automatically determined by the number of delay circuits, and the number of series transistor pairs in the grounded gate amplifier stage, this kind of circuit is not needed. In the event that the number of pulse fingers increases, the number of series transistors also increases, and there is concern about an effect of a parasitic component such as a parasitic capacitor but, as the number increases at the grounded gate stage, and the input and output impedance of the grounded gate stage is normally sufficiently low in comparison with the parasitic component, an effect thereof is not large.

Consequently, when using the mixer circuit 800 of the third embodiment, it is possible to amplify low noise of a received signal without generating a UWB-IR template signal, and to obtain a result of multiplying with the template signal. Moreover, as it is possible to turn the circuit current off when no signal is received, a standby time power consumption is extremely low. Also, as it is possible to generate one template pulse with one delay circuit row condition transition, with no need to generate a template pulse, it is possible to minimize a circuit for which a high speed operation is required.

According to the above description, a signal is generated in accordance with the logical product of D₋₁ and XDᵢ, and the logical product of Dᵢ and XDᵢ₊₁, at an up edge of the start-up signal D0, at which time a multiplication with the received signal is carried out but, by adding a small change to the circuit, it is possible to carry out a multiplication with the template signal at a down edge of D0 too. In this case, as a multiplication is possible at both signal transition times, the up edge and the down edge, at which the delay circuit column consumes power, it is possible to increase an amount of receivable information with respect to the circuit power consumption. To this end, each control signal is connected to a gate of the series transistors of the grounded gate amplifier stage, and furthermore, four transistor groups are made in addition to the transistor groups 831 to 834, and connected in series, so that the circuit operates in the condition of the logical product of Dᵢ₋₁ and XDᵢ, and the logical product of Dᵢ and XDᵢ₊₁.

With the mixer circuit 800 of the third embodiment, a low noise amplification, and a multiplication of the amplified signal with the template signal, without inputting a high speed template signal from the exterior, are carried out, and also, in a communication apparatus, such as a UWB-IR, which handles an intermittent signal, the mixer circuit 800 simultaneously has a switch function enabling an intermittent operation which consumes power only when there is a particularly effective signal. As such, when using the mixer circuit 800 of the third embodiment in a UWB-IR communication apparatus, and in particular in a receiving apparatus, it is possible to realize a considerable reduction in the apparatus' power consumption, and a simplification of the configuration.

### Fourth Embodiment

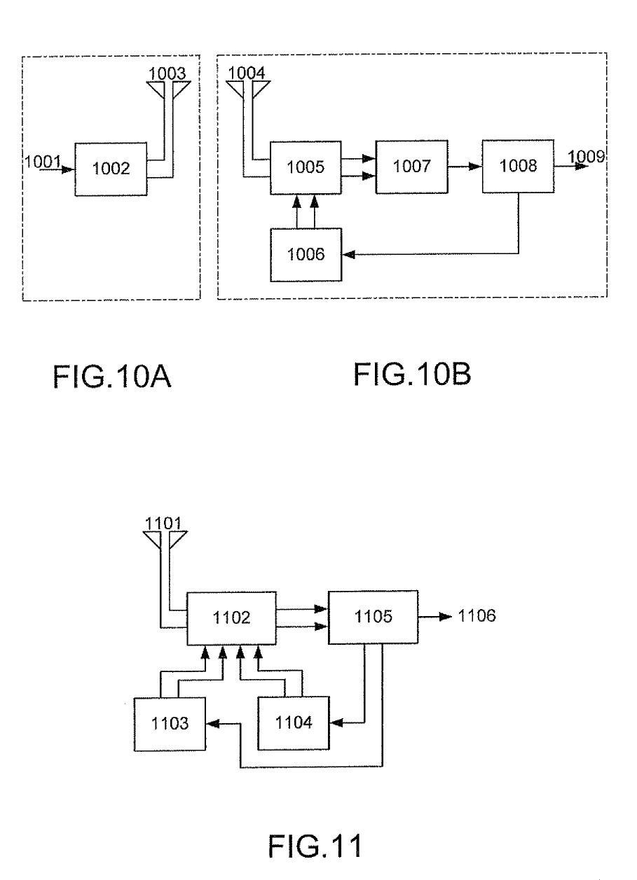

Next, a description will be given of a fourth embodiment of a mixer circuit. FIGS. 10A and 10B show an example of configuring a UWB-IR communication apparatus using the mixer circuits of the heretofore described embodiments. FIG. 10A shows a transmitting apparatus. Data to be transmitted are input into a terminal 1001. A pulse generator circuit 1002 generates a wideband pulse. At this time, the pulse generator circuit 1002 receives a transmission data signal input into the terminal 1001, and performs a predetermined modulation on the generated pulse. As a modulation method, a pulse position modulation (PPM), which displaces the generation position of the generated pulse, a bi-phase modulation (BPM), which inverts the polarity of the generated pulse, and the like, are often used. The modulated generated pulse is emitted into space via a transmission antenna 1003.

Herein, it is possible to use the mixer circuits of the heretofore described embodiments in the pulse generator circuit 1002. That is, it is sufficient that, as a grounded source stage input signal, serialized information to be transmitted is input as a baseband signal into the input terminals 103 and 104 (FIGS. 1, 6, 7, 8A, and 8B). In this case, when transmitting with a PPM, the timing of a start-up signal (a signal corresponding to the initialization signal IS of FIG. 3, or to D0 and XD0 of FIG. 8B) is adjusted in order to displace the pulse position. Also, in the case of a BPM, the polarity of a signal input into the input terminals 103 and 104 in synchronization with the start-up signal is changed. With the mixer circuits of the heretofore described embodiments, as the value of the multiplication of the template pulse synthesized in the mixer circuit (Ga-Gb of FIG. 2, or SUM1 and SUM2 of FIG. 9) and the heretofore described baseband signal is output in accordance with the logic of the baseband signal and the control signals G1 to G4 (FIGS. 1, 3, 6, and 7), or of D1 to D8 and XD2 to XD9 (FIGS. 8A and 9), a modulation of the UWB-IR can also be carried out simultaneously.

Next, a description will be given, with FIG. 10B, of a configuration of a receiving apparatus using the mixer circuits of the heretofore described embodiments. A signal received by an antenna 1004 is input into a mixer circuit 1005 of the heretofore described embodiments. As the mixer circuit 1005, it is possible to use the mixer circuits 1, 600, 700, and 800 shown in FIGS. 1, 6, 7, 8A, and 8B. As it is possible to process a differential signal with the mixer circuits 1, 600, 700, and 800, it is possible to use a balanced antenna as the antenna 1004 too. By handling a differential signal, it is possible to reduce the circuit power source voltage, lessen signal distortion, and the like. With the mixer circuits of the heretofore described embodiments, as they simultaneously have a low noise amplification function, and a function of generating a template signal and multiplying it with the amplified signal, this can be carried out in one of the circuits. A circuit 1006 being a circuit which generates a control signal to be transmitted to the mixer circuit 1005, it is possible to use the circuit shown in FIG. 3, 5, or 8B.

A received signal amplified by the mixer circuit 1005, and multiplied with the template pulse, is smoothed by an integrating circuit 1007, transmitted bit information is determined from the result thereof by a determination circuit 1008, and output from a terminal 1009 as a demodulated output. That is, the mixer circuit 1005 and the integrating circuit 1007 configure a correlator, and a correlation between the received signal and the template pulse is calculated by this circuit. The determination (demodulation) of the transmitted signal is carried out based on the result of the correlation calculation. The determination circuit 1008, also handling a control of the entire circuit, judges the timing of the next signal coming, and sends a start-up signal to the circuit 1006, which generates the control signal of the mixer circuit 1005, in synchronization with the demodulated signal, causing the control signal provided to the mixer circuit 1005 to be generated.

As the mixer circuits of the heretofore described embodiments simultaneously have a low noise amplification function, and a function of generating a template signal and multiplying the amplified input signal with the template signal, the configuration of the circuit becomes extremely simple. Also, with the mixer circuits of the heretofore described embodiments, the current consumed in the static condition (the standby condition), in which no start-up signal is input, being only a circuit component leakage current, is extremely low. As such, it is possible to make the system power consumption extremely low.

With the heretofore described configuration according to the fourth embodiment, it is also possible for the transmitting apparatus and receiving apparatus to share the same mixer circuit. By this means, in the event of configuring a transceiver apparatus wherein a transmitter and receiver are integrated, a further simplification of the configuration is possible.

### Fifth Embodiment

Next, a description will be given of a fifth embodiment of a mixer circuit. In the heretofore described embodiments, the control signals input into the mixer circuits are described as digital values which take two values, but it is also possible to input an analog signal such as a sine wave.

When inputting an analog signal, with the circuits of FIGS. 1, 6, and 7, which need four control signals, the control signals are divided into two pairs, G1 and G3 or G2 and G4, and differential signals v_{b1}±v₁, and v_{b2}±v₂, are input therein respectively. Herein, v_{b1} and v_{b2}, being in-phase components of the signals of the respective pairs, are biases given to the signals. A direct current, of which a normal voltage is constant, is given as v_{b1} and v_{b2}. Also, v₁ and v₂, being differential components, are analog control signals.

By applying signals in this way, when taking the input signal (the differential component of the signal given to the input terminals 103 and 104) to be vᵣ, a signal component v₁×v₂×vᵣ, expressed as a product of the three differential components, is included in an output signal appearing at the output terminal. Therefore, when thinking of sine waves of frequencies fᵣ, f₁, and f₂ as v_{r′}, v₁, and v₂, a signal with frequency components of fᵣ±f₁±f₂ is included in the output.

When setting fᵣ=f₁+f₂ (or f₁=f₂=fᵣ/2), vᵣ is frequency modulated, and can be reduced directly to a baseband. In this case, as the frequency of a local oscillator circuit is not the same as the frequency of vᵣ, the DC offset which is a problem in a large number of direct conversion type receivers does not occur. As such, not only with UWB, but also with a receiver in communication using a narrowband signal, which uses a normal phase modulation, frequency modulation, or amplitude modulation, it is possible to make a configuration thereof extremely simple.

FIG. 11 is a block diagram of when configuring a receiver according to the heretofore described principle. A signal received by an antenna 1101 is input directly into a mixer circuit 1102 of the heretofore described embodiments. As the mixer circuits of the heretofore described embodiments simultaneously have a low noise amplification function too, there is no need to place a low noise amplifier circuit preposing the mixer. Herein, it is possible to use the circuit illustrated in FIG. 1, 6, or 7.

Local oscillator circuits 1103 and 1104 generate a frequency of f₁ and f₂ respectively. Now, taking a frequency of a signal to be received to be fᵣ, by setting to fᵣ=f₁+f₂, the received signal is converted to a baseband. A circuit 1105 is configured of a filter, which extracts only a baseband component from the signal converted by the mixer circuit 1102, and a demodulation circuit. The received signal is demodulated in accordance with a received signal modulation method (such as a phase modulation, a frequency modulation, or an amplitude modulation), and information received is restored. As the local oscillator circuits 1103 and 1104 track the received signal by means of a phase lock loop or the like, and carry out a control such as consistently maintaining a phase difference between the received signal and a carrier wave constant, a high receiver performance can also be obtained.

According to the heretofore described embodiments, it is possible to configure a direct conversion type of receiver easily. The direct conversion type of receiver having no intermediate frequency amplifier stage, the configuration itself is simple, it has a high sensitivity in comparison with a heterodyne type which repeats a conversion any number of times, and is also highly resistant to interference and distortion, such as a cross-modulation, caused by a large signal. Moreover, although there is the serious problem of DC offset with a heretofore known direct conversion type, the DC offset does not occur with the mixer circuit of this embodiment. Furthermore, as the mixer circuit of this embodiment simultaneously has a low noise amplification function, it is possible to further simplify the circuit. Furthermore, by making the output potentials of the local oscillator circuits 1103 and 1104, applied as a control voltage to the mixer circuit 1102, predetermined values, as heretofore described, it is also possible to stop the operation of the heretofore described mixer circuit, and make the circuit current a minimum (almost zero). This is extremely effective in reducing the power consumption at the circuit standby time.

Heretofore, a description has been given of a case of having two local oscillator circuits, but it is also acceptable to input even more signals. Hereafter, a description will be given of a case of inputting an integral number n, which is two or more, of signals. A circuit wherein four transistor groups operating under the condition of the logical product of D₋₁ and XDᵢ, and the logical product of Dᵢ and XDᵢ₊₁, described in the third embodiment, are further added to the circuit of FIG. 8A, is an example of a circuit in which n=8. Herein, a signal column vᵢ (i=1 to n) is taken as a differential signal, and applied to Dᵢ and XDᵢ. Note that, although there is no XD1 terminal in FIG. 8A, it will be taken that XD9 is used in place of XD1. Also, although the D9 signal is needed in the switch group of the logical product of D₋₁ and XDᵢ, and the logical product of Dᵢ and XDᵢ₊₁, D1 will be used in its place. Generally, when disposing n pairs of series transistors in each group, a number of control signals equivalent to n+1 is necessary, but it will be taken that D1 and XD1 are applied to Dₙ₊₁ and XDₙ₊₁ respectively. By means of the heretofore described kinds of rule, on applying the signal column vᵢ between Dᵢ and XDᵢ as a differential signal, input signals vᵣ, and components of a product thereof, that is, components of vᵣ×v₁×v₂× . . . ×vₙ, appear at the outputs. By this means, a mixture of four or more frequencies is possible. A skilful use of this enables an application to a simplification of an instrument, a removal of a specific interference frequency, and the like.

Heretofore, a description has been given of embodiments of a mixer circuit but, these kinds of embodiment being in no way limiting, it is possible to carry them out in various ways without departing from the scope of the invention. Hereafter, a description will be given of modifications.

### First Modification

A description will be given of a first modification of a mixer circuit. In the first embodiment, a description has been given of a case in which an MOS type of transistor is used but, not being limited to this, it is possible to cause the mixer circuit to operate in exactly the same way by, for example, using a bipolar type of transistor, and applying an appropriate bias by substituting corresponding electrodes as follows: an emitter for the source, a base for the gate, and a collector for the drain.

### Second Modification

A description will be given of a second modification of a mixer circuit. By having three or more transistors configuring the grounded gate stage, rather than two, a greater diversity of control is possible by means of a combination of control signals and, in the event that an emission of a control signal is accompanied by some kind of restriction, the restriction is alleviated.

### Third Modification

A description will be given of a third modification of a mixer circuit. In the first embodiment, the differential signal is handled using two identical circuits, but by connecting the source of each of the grounded source stage transistors (the N channel transistors 101, 102 in FIGS. 1, 6, 7, and 8A) to a current source, and controlling in such a way that the current flowing into both transistors is consistently constant, it is possible to further reduce an in-phase gain, and also possible to further increase the effect of the differential amplification.

### Fourth Modification

A description will be given of a fourth modification of a mixer circuit. In the first embodiment, the differential signal is handled using two identical circuits, but by, on the contrary, using only one of the two circuits, it is also possible to handle a single ended signal. In this case, although there is an accompanying reduction in gain, the number of components used is reduced by half, and the power consumption is also reduced by half. It being acceptable that the control signal is also a single ended signal, the circuit is further simplified.

As heretofore described, according to the mixer circuit, it is possible to provide a mixer circuit which simultaneously has a low noise amplification function, a template pulse generation function, and a function of reducing power consumption at a standby time to a minimum. Using this, it is possible to configure an efficient UWB-IR receiver. Also, as it is also possible to provide a mixer circuit with no DC offset problem when using the mixer circuit in a receiver in a heretofore known narrowband type of communication, a direct conversion type of receiver configuration with a high performance and a simple configuration is possible.

The entire disclosure of Japanese Patent Application filed on Feb. 29, 2008 and 2009-041908 filed on Feb. 25, 2009 are expressly incorporated by reference herein.

What is claimed is:

1. A mixer circuit which outputs a first output signal and a second output signal, in which are mixed a first input signal and a second input signal, the mixer circuit comprising:
a first grounded source amplifier circuit which amplifies the first input signal;
a second grounded source amplifier circuit which amplifies the second input signal;
a first signal output unit which outputs the first output signal;
a second signal output unit which outputs the second output signal;
a first transistor group including n rows and m columns (n is an integer equal to or greater than two, m is an integer equal to or greater than two) of transistors connected between the first grounded source amplifier circuit and the first signal output unit;
a second transistor group including n rows and m columns of transistors connected between the first grounded source amplifier circuit and the second signal output unit;
a third transistor group including n rows and m columns of transistors connected between the second grounded source amplifier circuit and the first signal output unit;
a fourth transistor group including n rows and m columns of transistors connected between the second grounded source amplifier circuit and the second signal output unit; and
n×m×k (k is 1 or 2) control signal lines to which n×m×k control signals which drive the first transistor group and the second transistor group, and drive the third transistor group and the fourth transistor group.

2. The mixer circuit according to claim 1, wherein
a potential which blocks the first transistor group, the second transistor group, the third transistor group, and the fourth transistor group is included in at least one of the n×m×k control signals.

3. The mixer circuit according to claim 1, wherein
the n×m×k control signals are of two values, a potential of one of the two values is a potential which blocks the first transistor group, the second transistor group, the third transistor group, and the fourth transistor group, and a potential of the other is a predetermined bias value given to the first transistor group, the second transistor group, the third transistor group, and the fourth transistor group.

4. A communication apparatus, configured including the mixer circuit according to claim 1, which receives a UWB-IR signal, wherein
the n×m×k control signals of the mixer circuit include a pulse signal wider than a template pulse of the UWB-IR signal.

5. A communication apparatus configured including the mixer circuit according to claim 1, wherein
the n×m×k control signals of the mixer circuit including at least a signal having a component of a frequency f₁, and a signal having a component of a frequency f₂, a frequency fᵣ of a received signal coincides with either a sum of, or a difference between, the frequency f₁ and the frequency f₂.
